(19) United States
(12) Patent Application Publication
(10) Pub. No.: US 2026/0245911 A1
(43) Pub. Date: Aug. 20, 2026

(54) ALKALINE DRY-CELL BATTERY

(71) Applicant: Panasonic Intellectual Property Management Co., Ltd., Osaka (JP)

(72) Inventors: SATOSHI FUJIYOSHI, Osaka (JP); KEISUKE TAKAHASHI, Osaka (JP); JUN NUNOME, Kyoto (JP)

(21) Appl. No.: 19/153,871

(22) PCT Filed: Nov. 8, 2023
(86) PCT No.: PCT/JP2023/040230

§ 371 Date: Aug. 5, 2025

(30) Foreign Application Priority Data
Feb. 14, 2023 (JP) 2023-021094

(51) Int. Cl. H01M 4/62; H01M 4/38; H01M 4/70; H01M 10/28; H01M 50/489

(52) U.S. Cl. CPC H01M 4/628; H01M 4/38; H01M 4/70; H01M 10/283; H01M 50/489

(57) ABSTRACT

An alkaline dry battery includes a positive electrode which has a cylindrical shape and which is disposed in a battery case, a gelled negative electrode containing zinc powder and filled in a hollow portion of the positive electrode, and a separator disposed between the positive electrode and the negative electrode. The separator has a total air permeability within a range of 1.5 to 8.7 cc/cm²·s. The negative electrode contains a sulfate salt within a range of 0.01 to 0.5% by mass with respect to mass of the negative electrode in terms of sulfate ions.

### BACKGROUND

### 1. Technical Field

The present disclosure relates to an alkaline dry battery.

### 2. Description of the Related Art

An alkaline dry battery (e.g., an alkaline manganese dry battery) is widely used because the alkaline dry battery has a larger battery capacity than a manganese dry battery and can extract a larger current. The alkaline dry battery usually includes a positive electrode, a negative electrode, a separator disposed between the positive electrode and the negative electrode, and an alkaline electrolytic solution. The positive electrode contains manganese dioxide as a positive electrode active material. Various proposals have been made to improve the characteristics of alkaline dry batteries.

Patent Literature 1 discloses an alkaline battery separator containing an alkali-resistant fiber, a beaten cellulose fiber, and a binder, wherein a synthetic freeness is 700 ml or more in terms of a CSF value, a weight ratio of the alkali-resistant fiber to the beaten cellulose fiber is 28:72 to 72:28, and the beaten cellulose fiber contains a mercerized natural wood fiber having a freeness of 150 ml or more and less than 550 ml in terms of a CSF value. It is described that the alkaline battery separator preferably has an air permeability of 13 cc/cm²/sec or less.

Patent Literature 2 proposes that, in an alkaline battery including a positive electrode, a negative electrode containing zinc, and an electrolytic solution, a calcium compound or a sulfuric acid compound is added to at least one of the positive electrode, the negative electrode, and the electrolytic solution to prevent a decrease in discharge voltage under a heavy load discharge condition. According to Patent Literature 2, since sulfate ions migrate toward the negative electrode together with H₂O during discharge, the volume of the electrolytic solution in the vicinity of the negative electrode is sufficient even under the heavy load discharge condition, and a decrease in discharge voltage is suppressed.

### CITATION LIST

### Patent Literature

Patent Literature 1: WO 2017/047638
Patent Literature 2: Unexamined Japanese Patent Publication No. 2001-297776

### SUMMARY

From the viewpoint of reducing the production cost, it is conceivable to produce an alkaline dry battery using an inexpensive and general-purpose separator. However, such a general-purpose separator has high air permeability and low shielding properties. Therefore, zinc oxide is deposited inside the separator in the middle of medium load intermittent discharge, and an internal short circuit is likely to occur.

One aspect of the present disclosure relates to an alkaline dry battery including: a positive electrode which has a cylindrical shape and is disposed in a battery case; a gelled negative electrode which contains zinc powder and is filled in a hollow portion of the positive electrode; and a separator disposed between the positive electrode and the negative electrode. The separator has a total air permeability within a range of 1.5 to 8.7 cc/cm²·s. The negative electrode contains a sulfate salt within a range of 0.01 to 0.5% by mass with respect to mass of the negative electrode in terms of sulfate ions.

In the present disclosure, it is possible to suppress the occurrence of an internal short circuit during medium load intermittent discharge.

### BRIEF DESCRIPTION OF DRAWING

FIG. 1 is a partially exploded cross-sectional view illustrating an example of an alkaline dry battery according to an embodiment.

### DESCRIPTION OF EMBODIMENT

Hereinafter, an embodiment according to the present disclosure will be described with examples, but the present disclosure is not limited to the examples described below. In the following description, specific numerical values and materials may be exemplified, but other numerical values and other materials may be applied as long as the invention according to the present disclosure can be implemented. In the present specification, the expression “numerical value A to numerical value B” includes the numerical value A and the numerical value B, and can be read as “numerical value A or more and numerical value B or less”. In the following description, when lower limits and upper limits of numerical values relating to specific physical properties and conditions are exemplified, any of the exemplified lower limits and any of the exemplified upper limits can be arbitrarily combined as long as the lower limit is not equal to or greater than the upper limit. When a plurality of materials are exemplified, one of them may be selected and used alone, or two or more thereof may be used in combination.

Furthermore, the present disclosure encompasses a combination of matters recited in two or more claims arbitrarily selected from a plurality of claims recited in the claims. That is, the matters recited in two or more claims arbitrarily selected from a plurality of claims recited in the claims can be combined as long as no technical contradiction arises.

### (Alkaline Dry Battery)

The alkaline dry battery according to the present embodiment is an alkaline dry battery including a cylindrical positive electrode disposed in a battery case, a gelled negative electrode containing zinc powder and filled in a hollow portion of the positive electrode, and a separator disposed between the positive electrode and the negative electrode. The zinc powder includes zinc alloy powder. The separator has a total air permeability within the range of 1.5 to 8.7 cc/cm²·s. The negative electrode contains a sulfate salt within a range of 0.01 to 0.5% by mass with respect to the mass of the negative electrode in terms of sulfate ions.

Since the sulfate salt is contained in the negative electrode, an internal short circuit due to precipitation of zinc oxide in a use environment of medium load intermittent discharge is suppressed. Therefore, an alkaline dry battery excellent in medium load intermittent discharge characteristics can be realized using a relatively inexpensive separator having a total air permeability of 1.5 cc/cm²·s or more.

The precipitation of zinc oxide is considered to be caused by a phenomenon that OH⁻ ions in the electrolytic solution in the negative electrode are consumed by discharge, the pH of the electrolytic solution is lowered, and the pH of the electrolytic solution is changed toward neutrality, whereby the solubility of zinc ions dissolved in the electrolytic solution is lowered. In particular, in a use environment in which discharge is intermittently repeated for about one hour per day at a medium load of a current of about 250 mA to 500 mA, a local decrease in pH of the electrolytic solution is remarkable, and the electrolytic solution is likely to be locally neutralized. As a result, an internal short circuit due to precipitation of zinc oxide is likely to occur.

In an undischarged alkaline dry battery, the sulfate salt added to the negative electrode is hardly dissolved in the electrolytic solution because the electrolytic solution is strongly alkaline. However, when the pH of the electrolytic solution in the negative electrode decreases with discharge, the sulfate salt is easily dissolved, and the pH of the electrolytic solution further decreases to the acidic side. On the other hand, the solubility of zinc ions is lowest in a neutral state, and zinc ions are easily dissolved in an alkaline state and an acidic state. Therefore, since the sulfate salt is dissolved in the middle of the medium load intermittent discharge, the pH of the electrolytic solution is changed from neutrality to acidic side, whereby zinc ions are easily dissolved and precipitation of zinc oxide is suppressed.

Note that, under a discharge condition of a heavy load (for example, about 1 A), the discharge voltage of the alkaline dry battery usually decreases before the electrolytic solution becomes neutral, and the alkaline dry battery reaches the end of its life. Therefore, under such a condition, the problem of an internal short circuit due to precipitation of zinc oxide hardly occurs.

Since the content of the sulfate salt contained in the negative electrode is 0.01% by mass or more with respect to the mass of the negative electrode in terms of sulfate ions, the effect of suppressing an internal short circuit due to precipitation of zinc oxide can be sufficiently obtained. On the other hand, when the content of the sulfate salt is excessive, unevenness in the distribution of the sulfate salt inside the negative electrode increases, and thus unevenness in the pH of the electrolytic solution inside the negative electrode during discharge increases, which may rather promote an internal short circuit. From the viewpoint of suppressing pH unevenness of the electrolytic solution, the content of the sulfate salt may be 0.5% by mass or less with respect to the mass of the negative electrode in terms of sulfate ions. The content of the sulfate salt may be 0.01% by mass or more and 0.5% by mass or less, preferably 0.05% by mass or more and 0.3% by mass or less, and more preferably 0.08% by mass or more and 0.2% by mass or less.

Here, the content of the sulfate salt in terms of sulfate ions means the ratio of the mass of sulfate ions (SO₄²⁻) out of cations and sulfate ions constituting the sulfate salt contained in the negative electrode to the total mass of the negative electrode. The content of the sulfate salt is determined by disassembling an undischarged alkaline dry battery, collecting at least a part (for example, 80% or more) of the negative electrode, measuring the mass thereof, exposing the collected negative electrode to pure water to dissolve the sulfate salt in the pure water, and performing ion chromatography. The content of the sulfate salt in terms of the sulfate ions is determined by quantifying SO₄²⁻by ion chromatography and calculating the mass occupied in the negative electrode.

In the case where the content of the sulfate salt is within the above range, since the total air permeability of the separator is 8.7 cc/cm²·s or less, an internal short circuit due to precipitation of zinc oxide can be sufficiently suppressed. On the other hand, as the total air permeability of the separator is lowered, the internal short circuit is more easily suppressed, but the manufacturing cost increases. Since the total air permeability of the separator is 1.5 cc/cm²·s or more, it is possible to realize an alkaline dry battery in which an increase in production cost is suppressed and an internal short circuit is suppressed even when the alkaline dry battery is used in medium load intermittent discharge. The total air permeability of the separator may be 1.5 cc/cm²·s or more and 8.7 cc/cm²·s or less, and more preferably 1.5 cc/cm²·s or more and 5 cc/cm²·s or less.

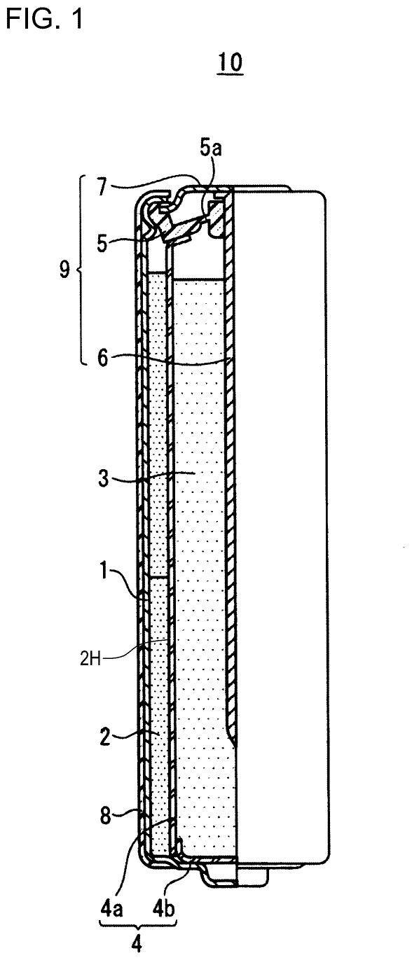

The total air permeability of a portion of the separator sandwiched between the positive electrode and the negative electrode may satisfy the above range. As an example of the structure of the separator, as shown in FIG. 1, which will be described later, there is a structure including a cylindrical portion sandwiched between the positive electrode and the negative electrode, and a bottom portion sandwiched between the negative electrode and the battery case. In this case, the total air permeability of at least the cylindrical portion out of the cylindrical portion and the bottom portion may satisfy the above range, and the total air permeability of the bottom portion is not particularly limited.

The total air permeability A of the separator is measured in accordance with the Frazier type air permeability tester method specified in JIS L 1096:2010, for the separator obtained by disassembling the alkaline dry battery after production to take the separator, washing the separator with a KOH aqueous solution having a concentration of 34% by mass, and allowing the separator to stand and dry under a reduced pressure condition at 20° C. for one day.

The separator can be formed so as to have a desired total thickness by stacking a plurality of separators each having a predetermined thickness, or by stacking a separator having a predetermined thickness while winding the separator a plurality of times. In this case, when a plurality of separators of the same type are stacked and used, the total air permeability A can be obtained by dividing the air permeability of one separator measured without stacking by the number of stacked separators. When different types of separators are stacked and used, the air permeability of the stacked separators is measured to determine the total air permeability A.

The total thickness of the separator may be 250 μm or more and 450 μm or less, preferably 270 μm or more and 400 μm or less, and more preferably 300 μm or more and 380 μm or less. The total thickness of the separator is an average value of thicknesses at three angularly equivalent points (e.g., three points adjacent to each other at a circumferential angle of 120°) of the cylindrical separator. In addition, the total thickness of the separator means the thickness in a state where the electrolytic solution has been absorbed in the battery.

The total thickness T of the separator is determined by obtaining a cross section of the alkaline dry battery after production by CT scanning and measuring the distance between the positive electrode and the negative electrode. The distance from the tip of the positive electrode terminal to the tip of the negative electrode terminal of the battery is defined as the total height. The distance between the positive and negative electrodes in a cross section at a height of 1/2 of the total height is measured at three angularly equivalent points (e.g., three points adjacent to each other at a circumferential angle of 120°), and the average value at the three points is defined as the total thickness T of the separator.

The cation constituting the sulfate salt is not particularly limited as long as it does not hinder the discharge reaction of the battery. The sulfate salt may be a salt of a metal cation and a sulfate ion. The sulfate salt preferably contains at least one selected from the group consisting of potassium sulfate salt, sodium sulfate salt, aluminum sulfate salt, aluminum potassium sulfate salt, calcium sulfate salt, zinc sulfate salt, and lithium sulfate salt, and also preferably contains a hydrate thereof, from the viewpoint of a large effect of lowering the pH after dissolution.

An alkaline dry battery according to the present disclosure includes a positive electrode, a negative electrode, a separator, and an electrolytic solution, and optionally includes other components. Examples of components of the alkaline dry battery according to the present disclosure will be described below.

### (Positive Electrode)

The positive electrode contains manganese dioxide as a positive electrode active material. The positive electrode usually contains a positive electrode active material and a conductive material, and further contains a binder as necessary. The positive electrode may be formed by pressure molding the positive electrode mixture (e.g., a positive electrode pellet) into a cylindrical body. The positive electrode mixture contains, for example, the positive electrode active material, the conductive material, and the alkaline electrolytic solution, and further contains the binder as necessary. The cylindrical body may be pressed so as to come into close contact with the inner wall of the case body after being accommodated in the case body.

A preferred example of manganese dioxide as the positive electrode active material is electrolytic manganese dioxide, but natural manganese dioxide or chemical manganese dioxide may also be used. Examples of the crystal structure of manganese dioxide include α type, β type, γ type, δ type, ε type, η type, λ type, and ramsdellite type.

The average particle diameter (D50) of the powder of manganese dioxide may be, for example, within the range of 25 μm to 60 μm from the viewpoint of easily ensuring the filling property of the positive electrode and the diffusiveness of the electrolytic solution in the positive electrode.

From the viewpoint of formability and suppression of expansion of the positive electrode, the BET specific surface area of manganese dioxide may be, for example, within the range of 20 m²/g to 50 m²/g. The BET specific surface area can be measured, for example, by using a specific surface area measuring device based on a nitrogen adsorption method.

The conductive material may be a conductive carbon material. Examples of the conductive carbon material include carbon black (such as acetylene black) and graphite. Examples of the graphite include natural graphite and artificial graphite. The conductive material may be in the form of powder. An average particle diameter (D50) of the conductive material may be within a range of 3 μm to 20 μm. The content of the conductive material in the positive electrode may be within the range of 3 parts by mass to 10 parts by mass (for example, within the range of 5 parts by mass to 9 parts by mass) with respect to 100 parts by mass of manganese dioxide.

In order to absorb hydrogen generated inside the battery, a silver compound may be added to the positive electrode. Examples of the silver compound include silver oxide (e.g., Ag₂O, AgO, and Ag₂O₃), and silver-nickel composite oxide (e.g., AgNiO₂).

### (Negative Electrode)

The negative electrode contains a zinc alloy powder as a negative electrode active material. From the viewpoint of corrosion resistance, the zinc alloy may contain at least one selected from the group consisting of indium, bismuth, and aluminum. The indium content in the zinc alloy may be, for example, within the range of 0.01% by mass to 0.1% by mass. The bismuth content in the zinc alloy may be, for example, within the range of 0.003% by mass to 0.02% by mass. The aluminum content in the zinc alloy may be, for example, within the range of 0.001% by mass to 0.03% by mass. The content of elements other than zinc in the zinc alloy may be within a range of 0.025% by mass to 0.08% by mass from the viewpoint of the corrosion resistance.

The average particle diameter (D50) of the zinc alloy powder may be within the range of 100 μm to 200 μm (for example, within the range of 110 μm to 160 μm) from the viewpoint of the filling property of the negative electrode and the diffusiveness of the electrolytic solution in the negative electrode. In the present specification, the average particle diameter is a median diameter (D50) at which a cumulative volume reaches 50% in a volume-based particle size distribution. The median diameter is determined using, for example, a laser diffraction/scattering particle size distribution analyzer.

The negative electrode includes a zinc alloy powder, a gelling agent, a surfactant, a sulfate salt, and an electrolytic solution. The negative electrode can be formed by mixing the zinc alloy powder, the gelling agent, the surfactant, the sulfate salt, and the electrolytic solution. From the viewpoint of more uniformly dispersing the additive (e.g., gelling agent and surfactant) in the negative electrode, the additive is preferably added in advance to the electrolytic solution used for producing the negative electrode. As the electrolytic solution, an electrolytic solution (e.g., alkaline electrolytic solution) described later can be used.

In order to improve the corrosion resistance, a compound containing a metal having a high hydrogen overvoltage, such as indium or bismuth, may be appropriately added to the negative electrode.

### (Negative Electrode Current Collector)

The alkaline dry battery of the present disclosure may include a negative electrode current collector inserted into the negative electrode. The material of the negative electrode current collector may be a metal (i.e., a single metal or an alloy). The material of the negative electrode current collector preferably contains copper, and may be an alloy containing copper and zinc (for example, brass). The negative electrode current collector may be subjected to a plating treatment such as tin plating, if necessary.

### (Separator)

As the separator, a non-woven fabric mainly composed of fibers or a microporous film made of a resin is used. Examples of the material of the fiber include cellulose and polyvinyl alcohol. The non-woven fabric may be formed by mixing cellulose fibers and polyvinyl alcohol fibers, or may be formed by mixing rayon fibers and polyvinyl alcohol fibers. Examples of the material of the microporous film include resins such as cellophane and polyolefin. When the separator is thin, a plurality of separators may be stacked and adjusted so as to reach the above thickness.

### (Electrolytic Solution)

As the electrolytic solution (e.g., alkaline electrolytic solution), for example, an alkaline aqueous solution containing potassium hydroxide is used. The concentration of potassium hydroxide in the alkaline electrolytic solution is preferably within the range of 30 to 50% by mass (for example, within the range of 30 to 40% by mass). The alkaline electrolytic solution may contain zinc oxide.

The alkaline electrolytic solution may contain a surfactant. By using the surfactant, the dispersibility of the negative electrode active material particles can be enhanced. As the surfactant, those exemplified for the negative electrode can be used. The content of the surfactant in the alkaline electrolytic solution is usually within the range of 0.001 to 0.5% by mass (for example, within the range of 0.002 to 0.2% by mass).

### (Battery Housing)

The battery housing is not particularly limited, and a housing corresponding to the shape of the battery may be used. The shape of the alkaline dry battery according to the exemplary embodiment is not particularly limited, and may be a cylindrical shape or a coin shape (including a button shape). The battery housing usually includes a battery case, a negative electrode terminal plate, and a gasket. As the battery case, for example, a bottomed cylindrical metal case is used. For example, a nickel-plated steel plate is used for the metal case. In order to decrease the contact resistance between the positive electrode and the battery case, the inner surface of the battery case may be coated with a carbon coating. The negative electrode terminal plate can be formed of the same material as that of the metal case, and can be formed of, for example, a nickel-plated steel plate.

Examples of the material of the gasket include polyamide, polyethylene, polypropylene, polyphenyl ether, and polyphenylene ether. From the viewpoint of the corrosion resistance to the alkaline electrolytic solution, the material of the gasket is preferably polyamide-6,6, polyamide-6,10, polyamide-6,12, or polypropylene. The gasket usually has an annular thin portion.

Hereinafter, an example of an embodiment according to the present disclosure will be specifically described with reference to the drawing. The constituent elements described above can be applied to the constituent elements of the exemplary alkaline dry battery described below. In addition, the constituent elements of the exemplary alkaline dry battery described below can be changed based on the above description. Further, the matters described below may be applied to the above-described embodiment.

FIG. 1 is a partially exploded cross-sectional view of an alkaline dry battery 10 having an inside-out structure according to the embodiment of the present disclosure. The alkaline dry battery 10 having a cylindrical shape includes a battery case 1, and a positive electrode 2, a negative electrode 3 (e.g., a gelled negative electrode), a separator 4, and an electrolytic solution (not shown) disposed in the battery case 1.

The battery case 1 is a bottomed cylindrical case and functions as a positive electrode terminal. The positive electrode 2 has a hollow cylindrical shape and is disposed so as to be in contact with the inner wall of the battery case 1. The negative electrode 3 is disposed in the hollow portion 2H of the positive electrode 2. The separator 4 is disposed between the positive electrode 2 and the negative electrode 3. The negative electrode has the features described above.

The separator 4 includes a cylindrical separator 4a and a bottom paper 4b. The separator 4a is disposed along the inner surface of the hollow portion 2H of the positive electrode 2, and separates the positive electrode 2 and the negative electrode 3 from each other. The bottom paper 4b is disposed at the bottom of the hollow portion 2H of the positive electrode 2, and separates the negative electrode 3 from the battery case 1. The total air permeability of the separator 4a is within the range of 1.5 to 8.7 cc/cm²·s.

The opening of the battery case 1 is sealed by a sealing unit 9. The sealing unit 9 includes a gasket 5, a negative electrode current collector 6, and a negative electrode terminal plate 7 functioning as a negative electrode terminal. The negative electrode current collector 6 has a nail shape having a head portion and a body portion. The negative electrode current collector 6 contains, for example, copper, and may be made of an alloy containing copper and zinc, such as brass. The negative electrode current collector 6 may be subjected to a plating treatment such as tin plating as necessary. The body portion of the negative electrode current collector 6 is inserted into a through hole provided in a central portion of the gasket 5, and is inserted into the negative electrode 3. The head portion of the negative electrode current collector 6 is welded to a central flat portion of the negative electrode terminal plate 7. The gasket 5 has a thin portion 5a having an annular shape.

The opening end of the battery case is swaged to the peripheral edge (i.e., the flange) of the negative electrode terminal plate 7 via the peripheral edge of the gasket 5. The outer surface of the battery case 1 is covered with an exterior label 8. The battery case 1, the gasket 5, and the negative electrode terminal plate 7 constitute a battery housing. The positive electrode 2, the negative electrode 3, the separator 4, and the alkaline electrolytic solution (not shown) are disposed in the battery housing.

A method for assembling the alkaline dry battery 10 is not particularly limited, and a conventional technique can be applied as necessary.

### EXAMPLES

The alkaline dry battery of the present disclosure will be described in more detail with reference to the examples.

### Inventive Example 1

### (1) Preparation of Electrolytic Solution (Alkaline Electrolytic Solution)

As an alkaline electrolytic solution, an alkaline aqueous solution containing potassium hydroxide (concentration: 33% by mass) and zinc oxide (concentration: 2% by mass) was prepared.

### (2) Preparation of Positive Electrode

Manganese dioxide (i.e., an example of the positive electrode active material) and graphite (i.e., an example of the conductive material) were mixed to obtain a mixture. They were mixed at a mass ratio of manganese dioxide:graphite=100:6. As the manganese dioxide, powder of electrolytic manganese dioxide (average particle diameter (D50): 40 μm) was used. As the graphite, graphite powder (average particle diameter (D50): 8 μm) was used.

An electrolytic solution was added to the mixture, and the mixture was sufficiently stirred and then compression-molded into flakes to obtain a positive electrode mixture. The mass ratio between the mixture and the electrolytic solution was mixture:electrolytic solution=100:2. As the electrolytic solution, the same electrolytic solution as the alkaline electrolytic solution prepared in the above section (1) was used.

Next, the flaky positive electrode mixture was pulverized into granules, and the granules were classified with a 10 to 100 mesh sieve to obtain granules. The obtained granules were press-molded into a hollow cylindrical shape (height: 10.8 mm) to obtain a positive electrode pellet (mass: 2.9 g).

### (3) Preparation of Negative Electrode

A zinc alloy powder, a surfactant, a gelling agent, a sulfate salt, and an electrolytic solution were mixed to obtain a gelled negative electrode. The materials other than the zinc alloy powder and the sulfate salt were mixed at a mass ratio of surfactant:gelling agent:electrolytic solution=0.005:2.4:100. As the electrolytic solution, the same electrolytic solution as the alkaline electrolytic solution prepared in the above section (1) was used. Potassium sulfate salt (K₂SO₄) was used as the sulfate salt, and the content thereof was 0.01% by mass with respect to the entire negative electrode in terms of sulfate ions. The content of the zinc alloy powder and the sulfate salt was 66% by mass with respect to the entire negative electrode. As the negative electrode active material, a zinc alloy powder containing 0.02% by mass of indium, 0.01% by mass of bismuth, and 0.005% by mass of aluminum was used. As the surfactant, an anionic surfactant was used. As the gelling agent, a mixture of a crosslinked polyacrylic acid and a crosslinked polyacrylic acid partial sodium salt was used.

### (4) Assembly of Alkaline Dry Battery

An alkaline dry battery was assembled by the following method using the above constituent elements. A procedure for assembling the battery will be described with reference to FIG. 1.

First, a coating agent (product name: Varniphite) manufactured by Nippon Graphite Industries, Ltd. was applied to the inner surface of a bottomed cylindrical case made of a nickel-plated steel plate to form a carbon coating having a thickness of about 10 μm, thereby obtaining a battery case 1. Next, four positive electrode pellets were vertically inserted into the battery case 1 and then pressurized to form the positive electrode 2 in close contact with the inner wall of the battery case 1. After a separator 4 having a bottomed cylindrical shape was disposed inside the positive electrode 2, the alkaline electrolytic solution prepared in the above section (1) was injected. In this way, the separator 4 was impregnated with the alkaline electrolytic solution. The battery case 1 was left in this state for a predetermined time to allow the alkaline electrolytic solution to permeate from the separator 4 into the positive electrode 2. Thereafter, the inside of the separator 4 was filled with 6.3 g of the gelled negative electrode 3.

The separator 4 was formed using a cylindrical separator 4a and a bottom paper 4b. As the cylindrical separator 4a and the bottom paper 4b, a non-woven fabric sheet obtained by mixing rayon fibers and polyvinyl alcohol fibers (mass ratio: 1:1) as main components was used. The separator 4a had a total air permeability of 1.5 cc/cm²·s.

The negative electrode current collector 6 was formed by pressing general brass into a nail shape and then plating the surface thereof with tin. The head of the negative electrode current collector 6 was electrically welded to a negative electrode terminal plate 7 made of a nickel-plated steel plate. Thereafter, the body portion of the negative electrode current collector 6 was press-fitted into the through hole at the center of the gasket 5 containing polyamide-6,10 as a main component. In this way, a sealing unit 9 including the gasket 5, the negative electrode current collector 6, and the negative electrode terminal plate 7 was produced.

Next, the sealing unit 9 was disposed at the opening of the battery case 1. At this time, the body portion of the negative electrode current collector 6 was inserted into the negative electrode 3. Next, the opening end of the battery case 1 was swaged to the peripheral edge of the negative electrode terminal plate 7 so as to sandwich the gasket 5, thereby sealing the opening of the battery case 1. In this way, the positive electrode 2, the negative electrode 3, the separator 4, and the alkaline electrolytic solution (not shown) were disposed in the battery housing.

Next, the outer surface of the battery case 1 was covered with the exterior label 8. In this way, an alkaline dry battery A1 according to the inventive example 1 was produced.

For the battery A1, a cross section at a height of 1/2 of the height from the positive electrode terminal at the bottom of the battery case 1 to the negative electrode terminal plate 7 was obtained by CT scanning, and the total thickness of the separator was determined by the method described above. The total thickness of the separator was 340 μm.

### (5) Evaluation

The battery was connected to a 3.90 resistor via a switch, and the switch was turned on at a duty ratio of one hour per day to perform intermittent discharge. Specifically, in an environment of 20±1° C., a cycle of discharging for 1 hour and then pausing for 23 hours was repeated. The above discharge cycle was repeated until the battery voltage reached 0.8 V.

For twenty alkaline dry batteries (N=20), the total discharge time from the start of the discharge until the battery voltage reached 0.8 V or less (that is, the total period during which the switch was on) was evaluated as the duration. When the duration was less than 8 hours, it was determined that an internal short circuit occurred during the discharge, and the number n of batteries having the duration of less than 8 hours was obtained.

### Inventive Examples 2 to 12 and Comparative Examples 1 to 8

At least one of the total air permeability of the separator 4a or the content ratio of the sulfate salt contained in the negative electrode was changed from the inventive example 1. Except for the above change, alkaline dry batteries A2 to A12 and B1 to B8 according to the inventive examples 2 to 12 and the comparative examples 1 to 8 were produced and evaluated in the same manner as in the inventive example 1.

In the comparative examples 1, 2, and 5, alkaline dry batteries were produced without adding a sulfate salt to the negative electrode to obtain batteries B1, B2, and B5, respectively.

For each of the batteries A2 to A12 and B1 to B8, a cross section at a height of 1/2 of the height from the positive electrode terminal at the bottom of the battery case 1 to the negative electrode terminal plate 7 was obtained by CT scanning, and the total thickness of the separator was determined by the method described above. As a result, the total thickness of the separator in each of the batteries A2 to A12 and B1 to B8 was the same as that of the battery A1.

Table 1 shows the evaluation results of the duration. In Table 1, for each of the batteries A1 to A12 and B1 to B8, the ratio n/N of the batteries having the duration of less than 8 hours is shown as the occurrence ratio of the internal short circuit. Table 1 also shows the total air permeability of the separator 4a and the content of the sulfate salt in the negative electrode of each of the batteries A1 to A12 and B1 to B8, together with the internal short-circuit occurrence ratio n/N. The content of the sulfate salt represents the percentage of the mass of sulfate ions in the sulfate salt with respect to the mass of the entire negative electrode.

As shown in Table 1, in the batteries A1 to A12 in which the total air permeability of the separator 4a is within the range of 1.5 to 8.7 cc/cm²·s and the content of the sulfate salt is within the range of 0.01 to 0.5% by mass in terms of sulfate ions, the internal short circuit is suppressed without increasing manufacturing cost.

TABLE 1

| | Total Air | | Internal |
|---|---|---|---|
| | Permeability | Sulfate Salt | Short Circuit |
| | of Separator | Content Ratio | Occurrence |
| Battery | (cc/cm² · s) | (% by mass) | Ratio |
| B1 | 1.3 | 0 | 0/20 |
| B2 | 1.5 | 0 | 3/20 |
| B3 | 1.5 | 0.005 | 2/20 |
| A1 | 1.5 | 0.01 | 0/20 |
| A2 | 1.5 | 0.05 | 0/20 |
| A3 | 1.5 | 0.1 | 0/20 |
| A4 | 1.5 | 0.5 | 0/20 |
| B4 | 1.5 | 0.7 | 2/20 |
| A5 | 4.7 | 0.01 | 0/20 |
| A6 | 4.7 | 0.5 | 0/20 |
| A7 | 6.3 | 0.01 | 0/20 |
| A8 | 6.3 | 0.5 | 0/20 |
| B5 | 8.7 | 0 | 8/20 |
| B6 | 8.7 | 0.005 | 5/20 |
| A9 | 8.7 | 0.01 | 0/20 |
| A10 | 8.7 | 0.5 | 0/20 |
| A11 | 8.7 | 0.1 | 0/20 |
| A12 | 8.7 | 0.5 | 0/20 |
| B7 | 8.7 | 0.7 | 3/20 |
| B8 | 9.1 | 0.5 | 3/20 |

In the battery B1, since the total air permeability of the separator 4a is 1.3 cc/cm²·s and a separator having a sufficiently low total air permeability and a high shielding property is used, the internal short circuit can be suppressed without adding a sulfate salt to the negative electrode. However, the number of steps required for producing the separator increases, and the material cost increases, so that the production cost increases.

In the battery B2, since the separator having a higher total air permeability than that of the battery B1 was used, the internal short circuit could not be suppressed, and the internal short circuit occurred at a not small rate. In the battery B3, since the sulfate salt was added to the negative electrode, the occurrence ratio of the internal short circuit was lower than that of the battery B2. However, in the battery B3, the content of the sulfate salt was as low as 0.005% by mass in terms of sulfate ions, and the internal short circuit could not be sufficiently suppressed. Similarly, in the batteries B5 and B6 in which the content of the sulfate salt was 0.005% by mass or less in terms of sulfate ions, the internal short circuit could not be sufficiently suppressed.

On the other hand, in the batteries B4 and B7, the content of the sulfate salt was 0.7% by mass in terms of sulfate ions, which was excessive. Therefore, in the batteries B4 and B7, the occurrence ratio of the internal short circuit was higher than that in the batteries A4 and A12, and the internal short circuit could not be suppressed. It is considered that this is because the unevenness of the distribution of the sulfate salt inside the negative electrode increases with the increase in the content of the sulfate salt, and the unevenness of the pH of the electrolytic solution inside the negative electrode increases, and as a result, the internal short circuit is rather promoted.

In the battery B8 in which the total air permeability of the separator 4a was higher than 8.7 cc/cm²·s, the internal short circuit could not be sufficiently suppressed only by adding the sulfate salt to the negative electrode.

### Inventive Examples 13 to 23

In the above section (3) Preparation of Negative Electrode, the sulfate salt added to the negative electrode was changed from potassium sulfate salt (K₂SO₄) of the inventive example 1. Except for the above, in the same manner as in the inventive example 1, alkaline dry batteries A13 to A23 according to the inventive examples 13 to 23 were produced and evaluated.

In the inventive examples 14 to 23, the total air permeability of the separator 4a was changed from that in the inventive example 1 to obtain batteries A14 to A23, respectively.

Table 2 shows the evaluation results of the batteries A13 to A23 together with the evaluation results of the batteries A1, A7, and A9. In Table 2, for each battery, the ratio n/N of the batteries having the duration of less than 8 hours is shown as the occurrence ratio of the internal short circuit. In Table 2, the total thickness of the separator and the type of sulfate salt contained in the negative electrode in each battery are shown together with the occurrence ratio n/N of the internal short circuit. The content of the sulfate salt of each battery shown in Table 2 is 0.01% by mass with respect to the mass of the entire negative electrode in terms of sulfate ions.

TABLE 2

| | Total Air | | Internal |
|---|---|---|---|
| | Permeability | | Short Circuit |
| | of Separator | | Occurrence |
| Battery | (cc/cm² · s) | Sulfate Salt | Ratio |
| A1 | 1.5 | K₂SO₄ | 0/20 |
| A7 | 6.3 | K₂SO₄ | 0/20 |
| A9 | 8.7 | K₂SO₄ | 0/20 |
| A13 | 1.5 | Na₂SO₄ | 0/20 |
| A14 | 6.3 | Na₂SO₄ | 0/20 |
| A15 | 8.7 | Na₂SO₄ | 0/20 |
| A16 | 8.7 | Al₂(SO₄)₃•16H₂O | 0/20 |
| A17 | 8.7 | KAl(SO₄)₂ | 0/20 |
| A18 | 8.7 | CaSO₄ | 0/20 |
| A19 | 8.7 | ZnSO₄ | 0/20 |
| A20 | 8.7 | Li₂SO₄•H₂O | 0/20 |
| A21 | 8.7 | Na₂SO₄•7H₂O | 0/20 |
| A22 | 8.7 | KAl(SO₄)₂•12H₂O | 0/20 |
| A23 | 8.7 | ZnSO₄•7H₂O | 0/20 |

As shown in Table 2, in the batteries A13 to A23, the internal short circuit could be suppressed regardless of the type of the sulfate salt added to the negative electrode.

### INDUSTRIAL APPLICABILITY

The present disclosure is applicable to alkaline dry batteries.

### REFERENCE SIGNS LIST

1 battery case
2 positive electrode
3 negative electrode
4 separator
4a cylindrical separator
4b bottom paper
5 gasket
5a thin portion
6 negative electrode current collector
7 negative electrode terminal plate
8 exterior label
9 sealing unit
10 alkaline dry battery

1. An alkaline dry battery, comprising:
a positive electrode having a cylindrical shape; the positive electrode including a hollow portion, the positive electrode being disposed in a battery case;
a negative electrode which is gelled; the negative electrode containing zinc powder, the negative electrode being filled in the hollow portion of the positive electrode; and
a separator disposed between the positive electrode and the negative electrode,
wherein
the separator has a total air permeability within a range of 1.5 to 8.7 cc/cm²·s, and
the negative electrode contains a sulfate salt within a range of 0.01 to 0.5% by mass with respect to mass of the negative electrode in terms of sulfate ions.

2. The alkaline dry battery according to claim 1, wherein
the sulfate salt includes at least one selected from the group consisting of potassium sulfate salt, sodium sulfate salt, aluminum sulfate salt, aluminum potassium sulfate salt, calcium sulfate salt, zinc sulfate salt, lithium sulfate salt, and hydrates thereof.
